(19) United States
(12) Patent Application Publication
(10) Pub. No.: US 2025/0050320 A1
(43) Pub. Date: Feb. 13, 2025

(54) MICROFIBER, METHOD OF FORMING THE SAME AND ELECTROCHEMICAL CATALYST INCLUDING THE SAME

(71) Applicant: NATIONAL SUN YAT-SEN UNIVERSITY, Kaohsiung (TW)

(72) Inventors: Kevin Chengwei CHIOU, Kaohsiung (TW); Chih-Chun HU, Kaohsiung (TW)

(21) Appl. No.: 18/798,846

(22) Filed: Aug. 9, 2024

Related U.S. Application Data
(60) Provisional application No. 63/518,884, filed on Aug. 11, 2023.

(30) Foreign Application Priority Data
Jul. 16, 2024 (TW) 113126589

(51) Int. Cl. B01J 35/58; B01J 23/80; B01J 35/33; B01J 35/40; B01J 37/00; B01J 37/08

(52) U.S. Cl. CPC B01J 35/58; B01J 23/80; B01J 35/33; B01J 35/40; B01J 37/0072; B01J 37/08

(57) ABSTRACT

A microfiber, a method of forming the same and an electrochemical catalyst including the same are provided. The method includes forming a one-dimensional (1D) nanomaterial; dispersing the 1D nanomaterial in a solvent to form a 1D nanomaterial dispersing agent; forming a Langmuir-Blodgett film on a surface of a liquid, in which the Langmuir-Blodgett film includes the 1D nanomaterial dispersing agent; and pulling up the Langmuir-Blodgett film from the liquid by using a needle to obtain the aligned microfiber. The 1D nanomaterial can be used to form the aligned microfiber by using such simple method, thereby being subsequently applied to the products such as electrochemical catalysts and others.

### CROSS-REFERENCE TO RELATED APPLICATION

This application claims priority to U.S. Provisional Application Ser. No. 63/518,884, filed Aug. 11, 2023, and Taiwan Application Serial Number 113126589, filed Jul. 16, 2024, the disclosures of which are incorporated herein by reference in their entireties.

### BACKGROUND

### Field of Invention

The present invention relates to a microfiber, a method of forming the same and an electrochemical catalyst including the same. More particularly, the present invention relates to an aligned microfiber, a method of forming the same and an electrochemical catalyst including the same.

### Description of Related Art

Nanomaterial has small size and high specific surface area, so it has various applications, such as applied in semiconductor, biomedicine, optoelectronics, energy, nano device and etc. The nanomaterial is defined as having nanoscale (such as 100 nm to 500 nm) in at least one dimension, and dimension of the nanomaterial is based on number of dimension outside the nanoscale range. For example, one dimensional (1D) nanomaterial means size of only one dimension is outside of nanoscale.

The 1D nanomaterial has excellent properties, so research related to the 1D nanomaterial has attracted great attention. The arranged 1D nanomaterial can have properties of high aspect ratio and high specific surface area. The aligned 1D nanomaterial has application in optical components, electrochemical devices and mechanical reinforcement. However, it is hard to combine nanofiber filament in alignment conventionally because intermolecular interactions of the 1D nanomaterial make it tend to cause aggregation and prevent from ordering assembly. Moreover, high aspect ratio of the 1D nanomaterial makes it entangle like macromolecules. Conventional alignment method for 1D nanomaterials has its limitation, such as material specificity, needing to add other additives, or breakage of the 1D nanomaterial, and etc.

Therefore, it is needed to provide a method of forming an aligned microfiber to apply on various 1D nanomaterial without causing any breakage on the 1D nanomaterial.

### SUMMARY

An aspect of the present invention provides a method of forming an aligned microfiber, which pull up Langmuir-Blodgett film by using a needle, thereby forming the aligned microfiber from a one-dimensional (1D) nanomaterial.

Another aspect of the present invention provides a microfiber formed by the method of the above aspect.

Yet another aspect of the present invention provides an electrochemical catalyst including the microfiber of the above aspect.

According to the aspect of the present invention, providing the method of forming an aligned microfiber. The method includes forming a one-dimensional (1D) nanomaterial; dispersing the 1D nanomaterial in a solvent to form a 1D nanomaterial dispersing agent; forming a Langmuir-Blodgett film on a surface of a liquid, wherein the Langmuir-Blodgett film comprises the 1D nanomaterial dispersing agent; and pulling up the Langmuir-Blodgett film from the liquid by using a needle to obtain the aligned microfiber.

According to an embodiment of the present invention, the 1D nanomaterial includes nanogold, nanosilver, nanocopper, nanopolystyrene, nanozinc oxide or combinations thereof.

According to an embodiment of the present invention, the 1D nanomaterial includes nanowire, nanotube, nanorod, nanofiber or combinations thereof.

According to an embodiment of the present invention, forming the Langmuir-Blodgett film includes dropping the 1D nanomaterial dispersing agent into the liquid; and leaving the liquid stand for 10 seconds to 20 minutes after dropping the 1D nanomaterial dispersing agent.

According to an embodiment of the present invention, the liquid is different from the solvent.

According to an embodiment of the present invention, the method further includes performing a sintering step on the aligned microfiber, in which a sintering temperature of the sintering step is in a range of 300° C. to 750° C., and a sintering time of the sintering step is 15 minutes to 8 hours.

According to an embodiment of the present invention, the aligned microfiber is a composite material consisting of copper oxide nanomaterial and zinc oxide nanomaterial.

According to an embodiment of the present invention, the 1D nanomaterial has an aspect ratio not smaller than 200.

According to the another aspect of the present invention, providing the microfiber, which is formed by the above method of forming the aligned microfiber.

According to an embodiment of the present invention, a diameter of the aligned microfiber is in a range of 5 μm to 100 μm.

According to the yet another aspect of the present invention, providing the electrochemical catalyst including the above microfiber.

According to the aspect of the present invention, providing the method of forming an aligned microfiber. The method includes providing a 1D nanomaterial dispersing agent; dropping the 1D nanomaterial dispersing agent into a liquid to form a Langmuir-Blodgett film; and pulling up the Langmuir-Blodgett film from one point of the Langmuir-Blodgett film by using a needle to obtain the aligned microfiber.

According to an embodiment of the present invention, the 1D nanomaterial dispersing agent comprises 1D nanomaterial, and the 1D nanomaterial includes nanogold, nanosilver, nanocopper, nanopolystyrene, nanozinc oxide or combinations thereof.

According to an embodiment of the present invention, the Langmuir-Blodgett film is formed in a condensed phase before pulling up the Langmuir-Blodgett film.

According to an embodiment of the present invention, a surface pressure of the condensed phase is in a range of 0.5 mN/m to 20 mN/m.

According to an embodiment of the present invention, the 1D nanomaterial dispersing agent includes copper nanowire and polystyrene nanofiber with zinc acetate, the method further includes performing a sintering step on the aligned microfiber to obtain a composite microfiber consisting of copper oxide and zinc oxide.

According to an embodiment of the present invention, the liquid is selected from the group consisting of alcohol, acetonitrile, dimethylforamide (DMF), dimethyl sulfoxide, N-methyl-2-pyrrolidone, chloroform and alkane.

Application of the aligned microfiber, the method of forming the same and the electrochemical catalyst including the same, the aligned microfiber is formed from the 1D nanomaterial by using a simple method, thereby increasing applicability of the microfiber.

It is to be understood that both the foregoing general description and the following detailed description are by examples, and are intended to provide further explanation of the invention as claimed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a flow chart of a method of forming an aligned microfiber according to some embodiments of the present invention.

FIGS. 2A and 2B are a Fourier Transform IR spectrum and a scanning electron microscopy image of synthesis example 1 of the present invention, respectively.

FIGS. 3A and 3B are a scanning electron microscopy (SEM) image and

a transmission electron microscopy image of synthesis example 2 of the present invention, respectively.

FIG. 4 is a transmission electron microscopy (TEM) image of synthesis example 3 of the present invention.

FIGS. 5A and 5B are a scanning electron microscopy image and a transmission electron microscopy image of synthesis example 4 of the present invention, respectively.

FIG. 6 is a scanning electron microscopy image of synthesis example 5 of the present invention.

FIGS. 7A to 7D are scanning electron microscopy images of embodiments 1-4 of the present invention, respectively.

FIG. 8 is a scanning electron microscopy image of embodiment 5 of the present invention.

FIG. 9A shows an energy-dispersive X-ray spectroscopy (EDS) mapping image and SEM image of embodiment 5 of the present invention.

FIGS. 9B and 9C are X-ray photoelectron spectroscopy (XPS) spectra of copper and zinc of embodiment 5 of the present invention.

FIG. 10A is a linear sweeping voltammetry plot of CuO/ZnO microfiber, CuO, Cu₂O and ZnO according to some embodiments of the present invention.

FIG. 10B is a Tafel plot in a catalyzed reaction of CuO/ZnO microfiber, CuO, Cu₂O and ZnO according to some embodiments of the present invention.

### DETAILED DESCRIPTION

Reference will now be made in detail to formation and application of the present embodiments of the invention. However, the embodiments provide various applicable invention concepts, which can be implemented in various contents. The discussed embodiments are provided to better elucidate the practice of the present invention and should not be interpreted in anyway as to limit the scope of same.

As used herein, “around,” “about,” “approximately,” or “substantially” shall generally mean within 20 percent, or within 10 percent, or within 5 percent of a given value or range.

A formation method of a Langmuir-Blodgett (LB) film is a method capable of forming a single-layer film of various kinds of materials, so the LB film can be used to arrange nanomaterials on a surface of a specific substance (solid or liquid). In the present invention, one-dimensional (1D) nanomaterials are dispersed in a three-dimensional space and traps nanoparticles of the nanomaterials into two-dimensional planes, thereby forming the LB film. Furthermore, the aforementioned nanoparticles are arranged in a 1D state and then aligned to microfiber. Therefore, the present invention provides an aligned microfiber and a method of forming the same such that the 1D nanomaterial can be orderly arranged and aligned to the microfiber by a simple method, thereby increasing applicability of the microfiber.

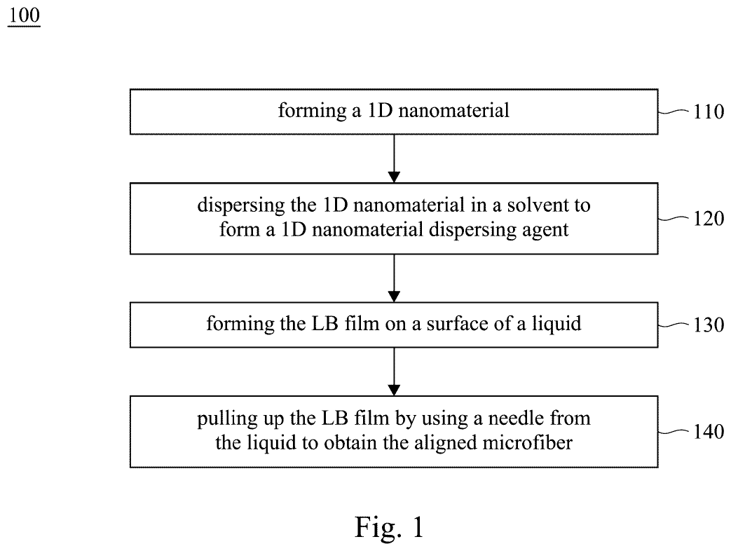

Referring to FIG. 1, FIG. 1 illustrates a flow chart of a method 100 of forming an aligned microfiber according to some embodiments of the present invention. The following discuss process operations of the aligned microfiber by using FIG. 1. The method 100 can also be referred to as Langmuir-Blodgett microfiber Drawing method (LBFD). First, operation 110 is performed to form a 1D nanomaterial. In the method of the present invention, there is no need to limit the material or the shape of the 1D nanomaterial, and there is no need to limit methods of forming various 1D nanomaterial; thus, the desired 1D nanomaterial can be made by various conventional methods for the synthesis thereof.

In some embodiments, the 1D nanomaterial includes nanogold, nanosilver, nanocopper, nanopolystyrene, nanozinc oxide or combinations thereof. In some embodiments, the 1D nanomaterial includes nanowire, nanotube, nanorod, nanofiber or combinations thereof. In some examples, the 1D nanomaterial is a composite material of copper nanowire and zinc oxide nanorod, or a composite material of copper nanowire and polystyrene nanofiber.

Subsequently, operation 120 is performed to disperse the above 1D nanomaterial in a solvent, thereby forming a 1D nanomaterial dispersing agent. In some embodiments, the solvent can be various alcohols (such as methanol, ethanol, isopropanol, propanol, tert-butanol, and etc.), acetonitrile, dimethylforamide (DMF), dimethyl sulfoxide, N-methyl-2-pyrrolidone (NMP), chloroform, various alkanes (such as hexane, pentane, decane, and etc.), or other suitable solvents, in which the suitable solvent is selected according to types of the 1D nanomaterial. It is noted that the suitable solvents enable slight dissolution of sub-components or rapid solvent evaporation.

Then, operation 130 is performed to form the LB film of the 1D nanomaterial on a surface of a liquid. The operation 130 includes dropping the 1D nanomaterial dispersing agent into the liquid, and allowing the liquid stand for 10 seconds to 20 minutes. In some embodiments, the aforementioned liquid can be alcohols (such as methanol, ethanol, isopropanol, propanol, tert-butanol, and etc.), acetonitrile, dimethylforamide (DMF), dimethyl sulfoxide, N-methyl-2-pyrrolidone (NMP), chloroform, various alkanes (such as hexane, pentane, decane, and etc.), or other suitable solvents. In some embodiments, the liquid should be different from the above solvent. Since the LB film is formed by aggregation of the material at gas-liquid interface, if the solvent was the same as the liquid, the solvent would pass through the gas-liquid interface during dropping the 1D nanomaterial dispersing agent; thus, the LB film could not be formed.

After the LB film forms a condensed phase, operation 140 is performed to pull up the LB film from the surface of the liquid, thereby obtaining the aligned microfiber. In some embodiments, a surface pressure of the condensed phase formed by the LB film is in a range of about 0.5 mN/m to about 20 mN/m. The LB film having the aforementioned surface pressure can form the microfibers with suitable diameters. In some embodiments, the averaged diameter of the microfiber is about 5 μm to about 100 μm.

In the pulling and drawing step, a needle for pulling and drawing the LB film provides an external stimulus to align the nanomaterial, and the 1D nanomaterials are arranged tightly with each other by Van der Waals force. The 1D nanomaterials are isotropically compressed during pulling and drawing the LB film to the microfiber, thereby strengthening intermolecular interaction thereof and helping the alignment of the 1D nanomaterials. In some embodiments, the above needle can be a pencil, a chopstick, a metal fork, a needle, a hook, and etc. It is understood that the LB film should be pull up by the needle from only one point of the LB film, thereby forming the microfiber.

In some embodiments, a sintering step is optionally performed on the obtained aligned microfiber, in which a sintering temperature of the sintering step is in a range of about 300° C. to about 750° C., and a sintering time of the sintering step is about 15 minutes to about 8 hours. In some embodiments, the sintering step can change chemical structures of components of the microfiber; moreover, if two or more kinds of microfiber are performed in the sintering step, an interaction may occur in the different components, thereby helping various applications.

By performing the dispersion of the 1D nanomaterial (operation 120), formation of the LB film (operation 130) and pull-up of the LB film (operation 140) in order, degrees of freedom of the 1D nanomaterials can be gradually decreased. When an aspect ratio of the 1D nanomaterial is greater, the 1D nanomaterial is more flexible to entangle and can have sufficient surface-to-volume ratio to make Van der Waals interaction lead intermolecular interactions. In some embodiments, the aspect ratio of the 1D nanomaterials is not smaller than 200, and not smaller than 1000 is preferable.

The above method 100 is used to obtain the microfiber of the aligned 1D nanomaterials. The obtained microfiber can have ordered assembled properties, thereby having various potential applications. The potential applications of the microfiber can include but not limit to electrochemical catalysts, electrical conductors, composite catalysts, miniature actuators, microfluidic devices, photonic structures, application in p-n junction forming method, and etc.

The following Embodiments are provided to better elucidate the practice of the present invention and should not be interpreted in anyway as to limit the scope of same. Those skilled in the art will recognize that various modifications may be made while not departing from the spirit and scope of the invention. All publication and patent applications mentioned in the specification are indicative of the level of those skilled in the art to which this invention pertains.

### Synthesis of 1D Nanomaterials

### Synthetic Example 1—Copper Nanowires

First, 33.5 mg of CuCl₂·3H₂O and 49.5 mg of glucose were dissolved in 5 mL of deionized (DI) water. In addition, 0.005 mL of oleic acid and 0.5 mL of oleylamine were dissolved in 0.875 mL of ethanol. The two solutions were combined, and the mixed solution was heated to 50° C. and stirred for 12 hrs. Subsequently, the mixed solution was put into a hydrothermal reactor and allowed to react at 120° C. for 6 hrs. The mixture after reaction was cooled to room temperature to recover a red-brown mixture. Then, 3 mL of hexane was added to the red-brown mixture. The mixture was transferred to Eppendorf Tubes or 15 mL Falcon tubes. The mixture was left to phase separate on its own after hand shaking for 5 minutes, in which the copper nanowire was gathered at the interface of hexane and water. A syringe was used to collect copper nanowires and then dispersed into hexane.

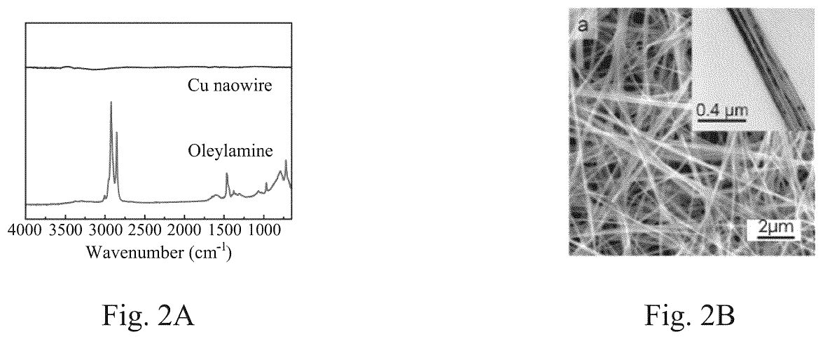

FIG. 2A was a Fourier Transform IR (FT-IR) spectrum of the purified copper nanowire and oleylamine, in which the horizontal axis was represented by the absorbance of light, the vertical axis was represented by the wavenumber (cm-1). FIG. 2A showed that the copper nanowire indeed had no oleylamine left. Additionally, a scanning electron microscopy (SEM) was used to observe the obtained copper nanowires. As shown in FIG. 2B, the copper nanowires were distributed disorderly.

### Synthetic Example 2—Silver Nanowires

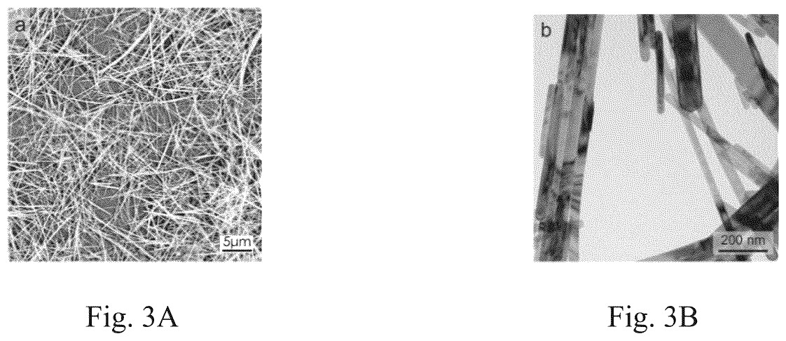

First, 4 g of polyvinylpyrrolidone (PVP) and 5 mg of NaCl were dissolved in 80 mL of ethylene glycol (EG) at 100° C. In addition, 0.82 g of AgNO₃ was dissolved in 40 mL of EG. Subsequently, the AgNO₃ solution was heated to 120° C. in an oil bath. Upon reaching 120° C., the PVP and NaCl solution was added into the AgNO₃ solution. The combined solution was allowed to react while stirring at 160° C. for 1.5 hr. The mixture was cooled to room temperature and was centrifuged. After centrifugation, the sediment silver nanowires were resuspended in ethanol. The centrifugation and redispersal process were repeated 3 times. The obtained silver nanowires dispersion was stored in ethanol. The SEM and a transmission electron microscopy (TEM) were used to observe the obtained silver nanowires, as shown in FIGS. 3A and 3B, the silver nanowires were distributed disorderly.

### Synthetic Example 3—Gold Nanowires

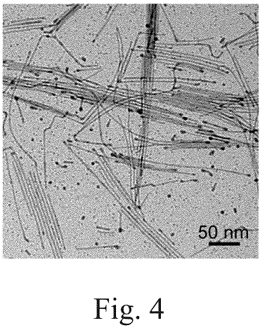

5.3 mg of HAuCl₄·3H₂O was added to 5 mL of hexanes. Subsequently, 0.18 mL of oleylamine was added to the hexane solution. After HAuCl₄·3H₂O dissolved, 0.25 mL of triisopropylsilane (TIPS) was added into the hexane solution as a reducing agent. The solution was mixed for 1 minute using a glass stirrer and left on its own for 48 hours at room temperature to have gold nanowires grow. Then, the mixture was centrifuged and resuspended with toluene. The centrifugation and sedimentation process were repeated 3 times to purify the gold nanowires. The obtained gold nanowires were dispersed in hexane. The TEM was used to observe the obtained gold nanowires, and as shown in FIGS. 4, the gold nanowires were distributed disorderly.

### Synthetic Example 4—Zinc Oxide Nanorod

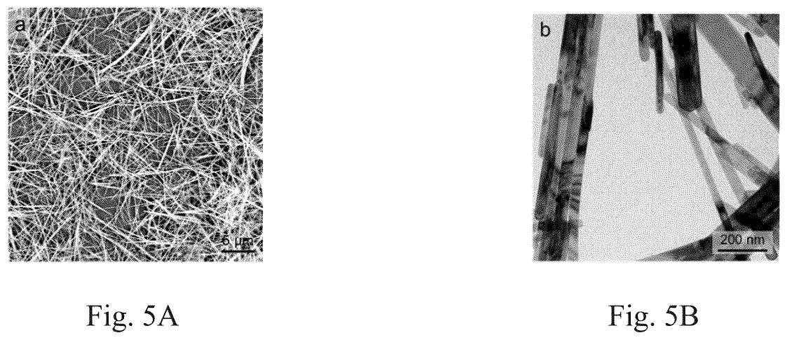

0.05 g of ZnCl₂, 5 g of Na₂CO₃, and 0.375 g of sodium dodecyl sulfate were added to 22.5 mL of DI water and stirred for 30 min. Subsequently, the mixture was put into a hydrothermal reactor and heated to 140° C. for 12 hr. Once the reaction completed, the solution was cooled to room temperature. The product was purified by 3 times repeats of filtration and redispersal in ethanol and 3 times with DI water. Finally, the filtered zinc oxide nanorod was dried at 60° C. for 4 hr and stored. The SEM and the TEM were used to observe the obtained zinc oxide nanorods, and as shown in FIGS. 5A and 5B, the zinc oxide nanorod were distributed disorderly.

### Synthetic Example 4—Polystyrene Nanofiber

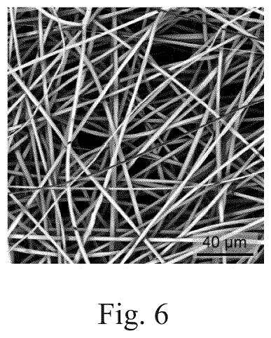

0.7 g of zinc acetate, 1.0 g of PS, and 1.5 g of Triton X-100 were dissolved into a mixture of 7.0 mL of dimethylformamide and 3.0 ml of chloroform to obtain a precursor solution. The mixture was stirred at 60° C. for 8 hours. Once the components completely dissolved, the precursor solution was loaded into a syringe with a stainless needle and connected to a high voltage source. At 0.4 mL/h syringe pump rate, the precursor solution was ejected towards a grounded stainless-steel collector spaced 15 cm away from the needle. The ejected solution was charged with a voltage of 18 kV and collected onto the conductive collector. The resultant polystyrene nanofibers with zinc acetate (PSZA) can be collected and redispersed in isopropanol. The TEM was used to observe the obtained gold nanowires, and as shown in FIGS. 6, the polystyrene nanofibers were distributed disorderly.

### Embodiment 1

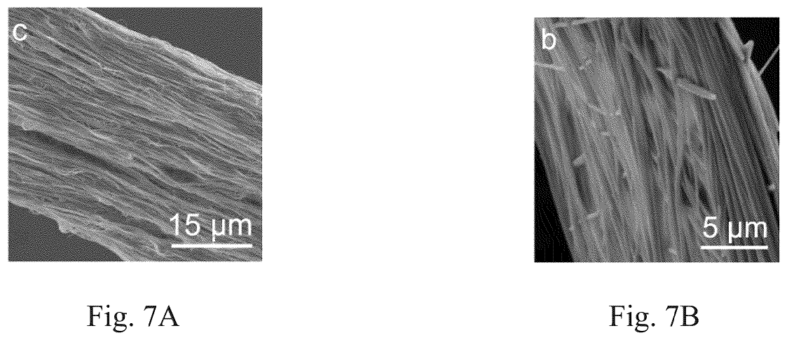

In Embodiment 1, ethanol was first added into a vessel, and then 1.0 mL of copper nanowire dispersing agent of synthetic example 1 was slowly dropped onto the ethanol surface. After dropping 1.0 mL of the dispersing agent, the vessel was left for 5 minutes. Once stabilized, a needle tip was used to pull from the LB film out of the liquid surface, and a microfiber was obtained. The SEM was used to observe the nanocopper microfiber, and as shown in FIG. 7A, the nanocopper microfiber was aligned toward the same direction orderly.

### Embodiments 2-4

Embodiments 2-4 used the same process as embodiment 1 to produce the microfiber, and the differences were the 1D nanomaterial used, in which embodiments 2-4 used the 1D nanomaterial formed by synthetic examples 2, 3 and 5, respectively. The SEM was also used to observe the obtained microfiber, and as shown in FIGS. 7B-7D, the microfibers were all aligned toward the same direction orderly.

### Embodiment 5

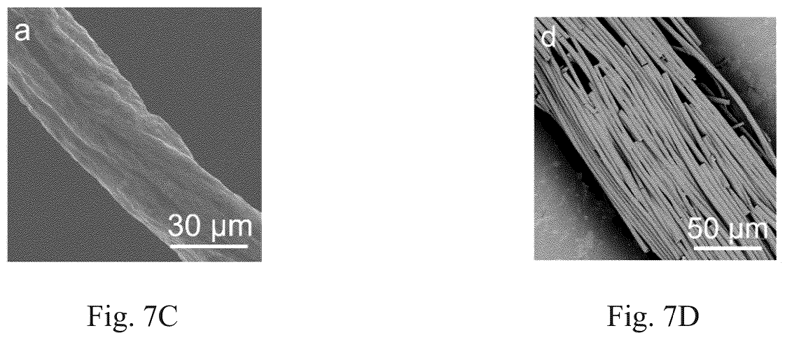

In Embodiment 5, ethanol was first added into a vessel, and then 1.0 mL of copper nanowire hexane dispersing agent of synthetic example 1 and 1.0 mL of polystyrene nanofiber including zinc acetate-isopropanol dispersing agent of synthetic example 5 were slowly dropped over ethanol surface. Once a reddish film formed over the ethanol and the surface stabilized, a needle was used to pull a microfiber from one point of the LB film. The obtained microfiber was further sintered to 600° C. in air for 4 hr to oxidize to CuO/ZnO microfiber. The SEM was used to observe the obtained CuO/ZnO microfiber, and as shown in FIG. 8, the CuO/ZnO microfiber was aligned toward the same direction orderly.

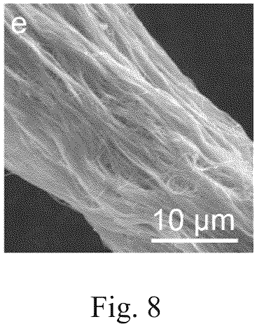

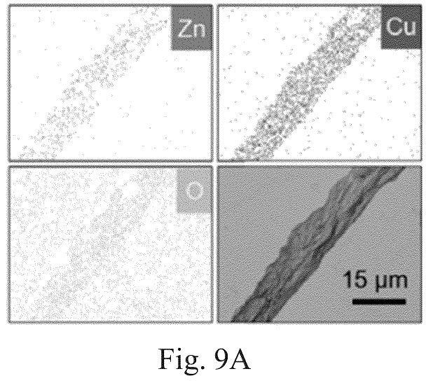

In addition, the CuO/ZnO microfiber of embodiment 5 was performed elemental analysis by using Energy-dispersive X-ray spectroscopy (EDS) and X-ray photoelectron spectroscopy (XPS), respectively. The results are shown in FIGS. 9A to 9C. FIG. 9A showed the EDS mapping images and SEM image (in which the lower right image was the SEM image, while the others were EDS mapping images) of embodiment 5 of the present invention. From EDS images in FIG. 9A, the CuO/ZnO microfiber indeed included zinc and copper simultaneously. In addition, FIGS. 9B and 9C were XPS spectra of copper and zinc of embodiment 5 of the present invention, in which the horizontal axis was represented by the binding energy (eV) of photo-electrons analyzed, and the vertical axis was represented by the total number of photo-electrons counted (Cts). FIG. 9B showed characteristic peak of Cu 2p_{3/2} in XPS spectrum, and compared copper oxide nanowire to the CuO/ZnO microfiber, the CuO/ZnO microfiber indeed had copper in oxidized state, and the peak was shifted to lower binding energy. FIG. 9C showed characteristic peak of Zn 2p_{3/2} in XPS spectrum, and compared zinc oxide nanowire to the CuO/ZnO microfiber, the binding energy of characteristic peak of zinc of the CuO/ZnO microfiber showed that it was zinc in oxidized state, and the peak was shifted to higher binding energy. Therefore, it could be inferred that the CuO/ZnO microfiber had complementary donor-acceptor interactions.

### Application Example

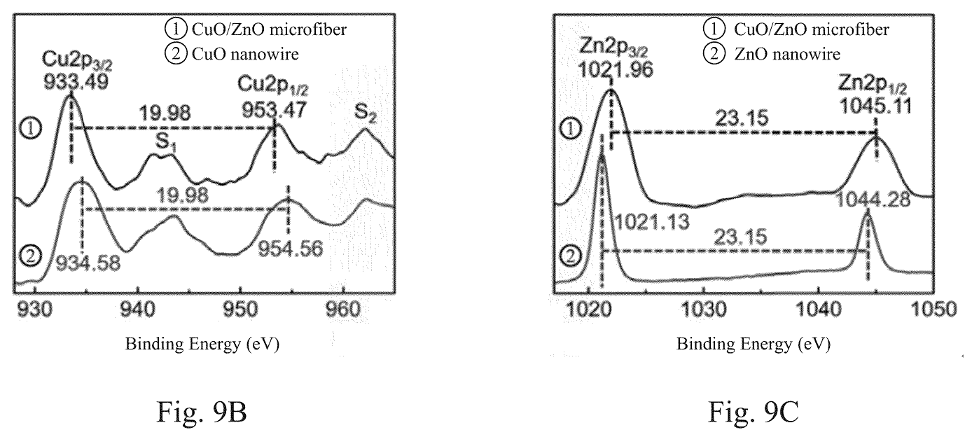

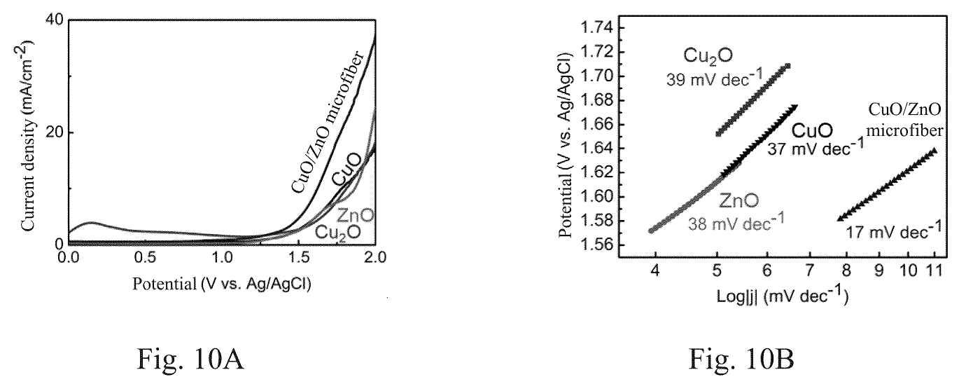

The CuO/ZnO microfiber of embodiment 5 was used as an electrochemical catalyst of water electrolysis. Linear sweeping voltammetry (LSV) was used to observe catalyzed effect of the CuO/ZnO microfiber, CuO, Cu₂O and ZnO. FIG. 10A was a linear sweeping voltammetry plot of CuO/ZnO microfiber, CuO, Cu₂O and ZnO according to some embodiments of the present invention, in which the horizontal axis was represented by the potential (V vs. Ag/AgCl), and the vertical axis was represented by the current density (mA/cm-2). As shown in FIG. 10A, in comparison with CuO, Cu₂O and ZnO, which showed potential values at 10 mA cm-2 as 1.86 V, 1.81 V and 1.76 V, respectively, the CuO/ZnO microfiber of embodiment 5 had better potential value of 1.625 V. In addition, FIG. 10B was a Tafel plot in a catalyzed reaction of CuO/ZnO microfiber, CuO, Cu₂O and ZnO according to some embodiments of the present invention, in which the horizontal axis was represented by the log[j] (mv dec⁻¹), and the vertical axis was represented by the potential (V vs. Ag/AgCl). FIG. 10B was a Tafel plot in the catalyzed reaction of CuO/ZnO microfiber, CuO, Cu₂O and ZnO. It is observed that Tafel slopes of CuO, Cu₂O and ZnO were 37 mV/dec, 38 mV/dec and 38 mV/dec, respectively, while the CuO/ZnO microfiber of embodiment 5 had lower Tafel slope of 17 mV/dec. Compared to the catalyst of single component, the CuO/ZnO microfiber can form a heterojunction between its two components, thereby further increasing the catalytic effect.

According to above embodiments, the present invention provides an aligned microfiber and a method of forming the same such that the 1D nanomaterial can be aligned to the microfiber by a simple method, thereby increasing applicability of the microfiber. Moreover, the aligned microfiber applied in the electrochemical catalyst shows great catalytic effect.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method of forming an aligned microfiber, comprising:
forming a one-dimensional (1D) nanomaterial;
dispersing the 1D nanomaterial in a solvent to form a 1D nanomaterial dispersing agent;
forming a Langmuir-Blodgett film on a surface of a liquid, wherein the Langmuir-Blodgett film comprises the 1D nanomaterial dispersing agent; and
pulling up the Langmuir-Blodgett film from the liquid by using a needle to obtain the aligned microfiber.

2. The method of forming the aligned microfiber of claim 1, wherein the 1D nanomaterial comprises nanogold, nanosilver, nanocopper, nanopolystyrene, nanozinc oxide or combinations thereof.

3. The method of forming the aligned microfiber of claim 1, wherein the 1D nanomaterial comprises nanowire, nanotube, nanorod, nanofiber or combinations thereof.

4. The method of forming the aligned microfiber of claim 1, wherein forming the Langmuir-Blodgett film comprises:
dropping the 1D nanomaterial dispersing agent into the liquid; and
leaving the liquid stand for 10 seconds to 20 minutes after dropping the 1D nanomaterial dispersing agent.

5. The method of forming the aligned microfiber of claim 1, wherein the liquid is different from the solvent.

6. The method of forming the aligned microfiber of claim 1, further comprising:
performing a sintering step on the aligned microfiber, wherein a sintering temperature of the sintering step is in a range of 300° C. to 750° C., and a sintering time of the sintering step is 15 minutes to 8 hours.

7. The method of forming the aligned microfiber of claim 6, wherein the aligned microfiber is a composite material consisting of copper oxide nanomaterial and zinc oxide nanomaterial.

8. The method of forming the aligned microfiber of claim 1, wherein the 1D nanomaterial has an aspect ratio not smaller than 200.

9. An aligned microfiber, formed by the method of forming the aligned microfiber of claim 1.

10. The aligned microfiber of claim 9, wherein a diameter of the aligned microfiber is in a range of 5 μm to 100 μm.

11. An electrochemical catalyst, comprising the aligned microfiber of claim 9.

12. A method of forming an aligned microfiber, comprising:
providing a 1D nanomaterial dispersing agent;
dropping the 1D nanomaterial dispersing agent into a liquid to form a Langmuir-Blodgett film; and
pulling up the Langmuir-Blodgett film from one point of the Langmuir-Blodgett film by using a needle to obtain the aligned microfiber.

13. The method of forming the aligned microfiber of claim 12, wherein the 1D nanomaterial dispersing agent comprises 1D nanomaterial, and the 1D nanomaterial comprises nanogold, nanosilver, nanocopper, nanopolystyrene, nanozinc oxide or combinations thereof.

14. The method of forming the aligned microfiber of claim 12, wherein the Langmuir-Blodgett film is formed in a condensed phase before pulling up the Langmuir-Blodgett film.

15. The method of forming the aligned microfiber of claim 14, wherein a surface pressure of the condensed phase is in a range of 0.5 mN/m to 20 mN/m.

16. The method of forming the aligned microfiber of claim 12, wherein the 1D nanomaterial dispersing agent comprises copper nanowire and polystyrene nanofiber with zinc acetate, the method further comprises:
performing a sintering step on the aligned microfiber to obtain a composite microfiber consisting of copper oxide and zinc oxide.

17. The method of forming the aligned microfiber of claim 12, wherein the liquid is selected from the group consisting of alcohol, acetonitrile, dimethylforamide (DMF), dimethyl sulfoxide, N-methyl-2-pyrrolidone, chloroform and alkane.
